(19) United States
(12) Patent Application Publication
(10) Pub. No.: US 2011/0168496 A1
(43) Pub. Date: Jul. 14, 2011

(54) ELEVATOR INSTALLATION MAINTENANCE

(76) Inventor: Adrian Bunter, Beckenried (CH)

(21) Appl. No.: 12/997,718

(22) PCT Filed: Jun. 15, 2009
(86) PCT No.: PCT/EP2009/057380

§ 371 Date: Mar. 10, 2011

(30) Foreign Application Priority Data
Jun. 13, 2008 (EP) PCT/EP2008/057514

(51) Int. Cl. B66B 3/00; B66B 13/02; B66B 1/28

(52) U.S. Cl. 187/247; 187/325

(57) ABSTRACT

The disclosure relates to an elevator installation and a method for maintenance of such an elevator installation. The elevator installation comprises at least one door and at least one acceleration sensor. The acceleration sensor is mounted on the door, for example.

The invention relates to a lift installation and to a method for maintenance of such a lift installation according to the introductory part of the independent claims.

EP 14159337 A1 describes a device and a method for remote maintenance of a lift installation, which device is installed at the lift installation and receives first signals from a sensor of the lift installation, for example from an acceleration sensor. The device converts received first signals into second signals and passes on these second signals for evaluation to a remote maintenance centre by way of a telecommunications network.

WO0200702030322A1 describes a further device and a further method for the positioning of a lift installation, in that a first acceleration sensor is placed on a cage and an additional acceleration sensor is placed on a cage door, which allows for an independent determination of acceleration of the cage and of acceleration of the cage door. The positions of the cage and the cage door are determined through a double integration of the accelerations.

The present invention has the object of further developing this device and this method. This object is fulfilled by the invention in accordance with the definition of the independent claims.

According to the invention the lift installation comprises at least one door and at least one acceleration sensor; the door is a cage door and/or a storey door. The acceleration sensor is mounted on the door and measures acceleration and/or vibration on the door; the acceleration sensor is attached to at least one movable section of the door using at least one attachment substance.

This has the advantage that the acceleration sensor can directly detect the opening and/or closing of the door. The acceleration sensor is attached to a movable section of the door, which makes it possible to detect movements, accelerations and vibrations during the opening and closing of the door. The acceleration sensor can be attached to cage door as well as a storey door, which makes it possible to monitor both doors.

Advantageous developments of this installation are described in the claims dependent thereon.

Advantageously, the door is a cage door of a cage and the acceleration sensor detects accelerations and/or vibrations of the cage.

This is an advantage, since the cage door is the location where an acceleration sensor can detect all movements, accelerations and vibrations of the cage door and the cage. Also, only a single acceleration sensor is needed.

Advantageously, the acceleration sensor detects at a storey stop, when the cage is stationary, accelerations and/or vibrations of the cage door. During travel of the cage, when the cage door is stationary, the acceleration sensor detects accelerations and/or vibrations of the cage.

This has the particular advantage that the detected movements, accelerations and vibrations can be uniquely associated with either the cage door or the cage.

The acceleration sensor provides accelerations and/or vibrations of the door or accelerations and/or vibrations of the cage through at least one communication path to at least one communications module. The communications module can be placed in a fixed location on the lift installation or in a mobile location on the cage and/or on at least one movable section of the door. This has the advantage, that the communications module can be placed as desired in the lift installation.

Advantageously, at least one energy store is attached to at least one movable door section, which provides electricity to the acceleration sensor and/or the communications module. Advantageously, the energy store provides energy-independence for the acceleration sensor and/or the communication module for at least one year.

If the acceleration sensor and/or the communications module are provided with electricity from an energy store, which is independent of the electricity source of the lift installation and/or the building, the installation of cables can be disposed with. As such, the invention is appropriate for retrofitting, especially with radio signal transmission.

Advantageously, the movable door section is a door panel and/or a door strip.

This is advantageous, as the acceleration sensor can be attached to a planar door panel as well as to an elongated door strip. The installer has great freedom with the installation of the acceleration sensor. On a planar door panel the acceleration sensor can be placed with a flat contact, and on an elongated door strip the acceleration sensor can be placed with a point contact.

Advantageously, the acceleration sensor is placed between two door sections in the interior of the door, thus unnoticeable by passengers and protected from theft and vandalism.

Advantageously, the acceleration sensor has dimensions of 50×50×10 mm³, preferably 30×30×5 mm³, preferably 20×20×2 mm³. Advantageously, the acceleration sensor weighs 10 grams, preferably 5 grams.

This has the advantage that the acceleration sensor is of small and light construction.

Advantageously, the communications path is a signal cable such as a USB cable. The USB cable also realises, apart from communication of the acceleration signals, an electrical power supply of the acceleration sensor. Advantageously, the communication path is a radio connection such as Bluetooth and/or ZigBee and/or WiFi.

This is of further advantage, since the communication path can be realised by a standardised and economic USB cable and/or a standardised and economic Bluetooth and/or ZigBee and/or WiFi.

Advantageously, the communications module communicates bidirectionally in at least one network with at least one user module.

This is of particular advantage, since the communications module communicates with a user module independently of the lift installation.

Advantageously, the user module is located in at least one central station and/or with at least one maintenance engineer. Advantageously, the central station is located remotely from the building of the lift installation and/or the central station is located in the building of the lift installation. Advantageously, the network is a radio network and/or a fixed network.

This is similarly of advantage, since the communications module can communicate with a desired user module of a central station and/or a mobile maintenance engineer remote from or near the building.

Advantageously, the communications module communicates detected acceleration signals and/or at least one item of maintenance information and/or at least one alarm report to the user module.

The invention also relates to a method for maintenance of a lift installation with at least one door and at least one acceleration sensor, in which accelerations and/or vibrations of the door are detected by the acceleration sensor; accelerations and/or vibrations of the door measured by the acceleration sensor are transmitted as acceleration signals through at least one communications path to a communications module; acceleration signals processed by the communications module are sent by at least one network to a user module.

This has the advantage that the accelerations and vibrations recorded by the acceleration sensor can be transmitted, through a communications module and independent of the lift installation, to a user module.

Advantageous developments of this method are described in the claims dependent thereon.

Advantageously, at lease one computer program means is loaded by way of at least one signal line from at least one computer readable data memory into at least one processor of the communications module and/or of the user module. Detected acceleration signals are evaluated by the computer program means.

This has the particular advantage that acceleration signals detected by the computer program means are logically linked and intelligently evaluated.

Advantageously, “acceleration of the door” and/or “acceleration of the cage” and/or “opening acceleration or closing acceleration of the door” and/or “upward acceleration or downward acceleration of the cage” and/or “speed of the door” and/or “speed of the cage” and/or “opening speed or closing speed of the door” and/or “upward speed or downward speed of the cage” and/or “travel path of the door” and/or “travel path of the cage” and/or “opening travel path or closing travel path of the door” and/or “upward travel path or downward travel path of the cage” and/or “time instant of the start of acceleration of the door” and/or “time instant of the end of deceleration of the door” and/or “number of door movements” and/or “time duration of the door movement” and/or “time instant of the start of acceleration of the cage” and/or “time instant of the end of deceleration of the cage” and/or “number of cage journeys” and/or “number of storey stops of the cage” and/or “time duration of a cage journey” and/or “time duration of a storey stop of the cage” and/or “horizontal vibrations of the door” and/or “vertical vibrations of the door” and/or “horizontal vibrations of the cage” and/or “vertical vibrations of the cage” is evaluated from the detected acceleration signals as at least one item of maintenance information.

Advantageously, at least one item of maintenance information “number of door movements” and/or “number cage journeys” and/or “number of storey stops of the cage” and/or “time duration of a cage journey” or “time duration of a storey stop of the cage” is summated in freely selectable time windows; and that an item of maintenance information “time plot of the door movements” and/or “time plot of the cage journeys” and/or “time plot of the storey stops of the cage” is provided as the result of the summation.

This brings the advantage that a plurality of maintenance-relevant characteristic values is obtained from detected acceleration signals.

Advantageously, the summation of an item of maintenance information is carried out specifically to storey.

This brings the further advantage that maintenance-relevant characteristic values of the lift installation can be prepared in storey-specific manner.

Advantageously, at least one item of maintenance information is compared by the computer program means with at least one reference value. The reference value is loaded by way of the signal line from the computer readable data memory into the processor.

Advantageously, in the case of a negative comparison result at least one alarm report is generated by the computer program means. In the case of a positive comparison result, at least one serviceability report is generated by the computer program means.

This has the advantage that clear and meaningful reports are generated by the computer program means.

Advantageously, an alarm report is generated if an “acceleration of the door” and/or an “acceleration of the cage” and/or a “speed of the door” and/or a “speed of the cage” and/or a “travel path of the door” and/or a “travel path of the cage” and/or a “time duration of the door movement” and/or a “time duration of the cage journey” and/or a “time duration of a storey stop of the cage” and/or a “number door movements” and/or a “number of cage journeys” and/or a “number of storey stops of the cage” and/or “horizontal vibrations of the door” and/or “vertical vibrations of the door” and/or “horizontal vibrations of the cage” and/or “vertical vibrations of the cage” exceeds a reference value.

Advantageously, an alarm report is generated if an “acceleration of the door” and/or an “acceleration of the cage” and/or a “speed of the door” and/or a “speed of the cage” and/or a “travel path of the door” and/or a “travel path of the cage” and/or a “time duration of the door movement” and/or a “time duration of the cage journey” and/or a “time duration of a storey stop of the cage” and/or a “number door movements” and/or a “number of cage journeys” and/or a “number of storey stops of the cage” and/or “horizontal vibrations of the door” and/or “vertical vibrations of the door” and/or “horizontal vibrations of the cage” and/or “vertical vibrations of the cage” and/or a “time plot of the door movements” and/or a “time plot of the cage journeys” and/or a “time plot of the storey stops of the cage” deviates from a reference value.

Advantageously, a serviceability report is generated if an “acceleration of the door” and/or an “acceleration of the cage” and/or a “speed of the door” and/or a “speed of the cage” and/or a “travel path of the door” and/or a “travel path of the cage” and/or a “time duration of the door movement” and/or a “time duration of the cage journey” and/or a “time duration of a storey stop of the cage” and/or a “number door movements” and/or a “number of cage journeys” and/or a “number of storey stops of the cage” and/or “horizontal vibrations of the door” and/or “vertical vibrations of the door” and/or “horizontal vibrations of the cage” and/or “vertical vibrations of the cage” falls below a reference value.

Advantageously, acceleration signals detected by the communications module and/or at least one item of maintenance information and/or at least one alarm report is or are communicated in the network to at least one user module of at least one central station and/or of at least one maintenance engineer.

This is of advantage, since the central station and/or the maintenance engineer can prepare and undertake maintenance actions of the lift installation with meaningful maintenance data.

Advantageously, an alarm report is communicated to the central station. Acceleration signals communicated with the alarm report and/or an item of maintenance information communicated with the alarm report is or are investigated by the central station. If at least one disturbance, which is linked with the alarm report, of the lift installation cannot be eliminated in another mode and manner at least one maintenance engineer who undertakes appropriate maintenance of the lift installation in the building of the lift installation is summoned by the central station.

Advantageously, an item of maintenance information “time plot of the door movement” is investigated by the maintenance engineer in the central station and/or on the way to the lift installation and the correct opening and/or closing of at least one door is established in storey-specific manner.

Advantageously, a favourable point in time, where, in particular, little traffic is to be expected and a possible switching-off of the cage of the lift installation causes little disturbance, for a maintenance visit is derived by the central station and/or by the maintenance engineer from the item of maintenance information “time plot of the cage journeys”.

This brings the advantage that the maintenance engineer can determine his or her maintenance visit in terms of time so that a temporary non-availability of the lift installation causes fewest possible disadvantages for the passengers.

Advantageously, a computer program product comprises at least one computer program means suitable for realising the method for maintenance of a lift installation in that at least one method step is performed when the computer program means is loaded into the processor of a communications module and/or of a user module.

Advantageously, the computer readable data memory comprises such a computer program product.

The invention also relates to a method for modernisation of an existing lift installation with at least one door and at least one cage; at least one acceleration sensor is mounted on the door; at least one communications module is mounted in stationary position at the lift installation or to be mobile at the cage; the acceleration sensor is connected with the communications module by way of at least one communications path.

This has the advantage that the modernisation of an existing lift installation can be performed simply and quickly. The expert has great freedom not only in the location of mounting of acceleration sensor and/or communications module, but also in the mode and manner of the communications path.

Advantageous developments of this method are described in the claims dependent thereon.

Exemplifying embodiments of the invention are explained in detail by way of the figures, for which purpose:

FIG. 1 shows a schematic view of a part of a first exemplifying embodiment of a lift installation with an acceleration sensor at a cage door;

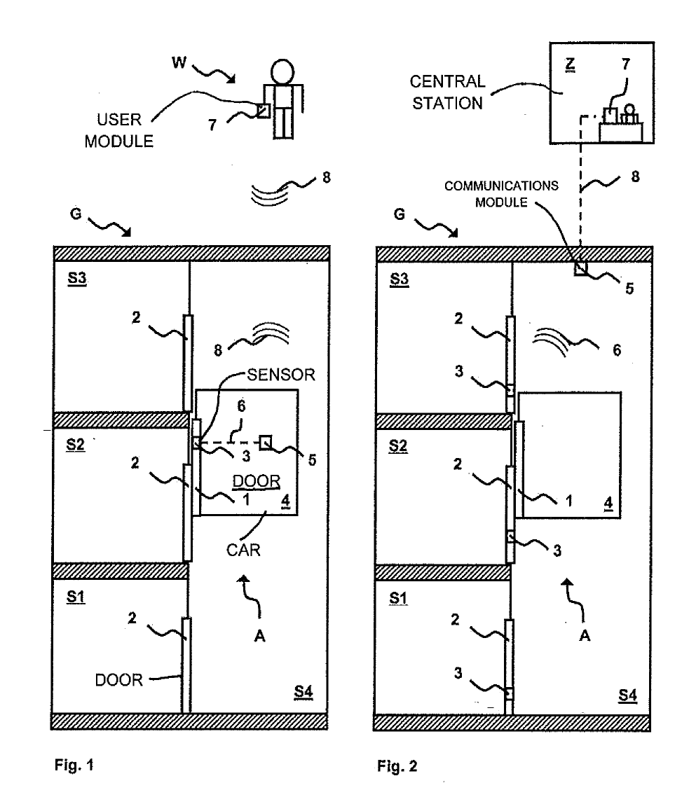

FIG. 2 shows a schematic view of a part of a second exemplifying embodiment of a lift installation with an acceleration sensor at each storey door;

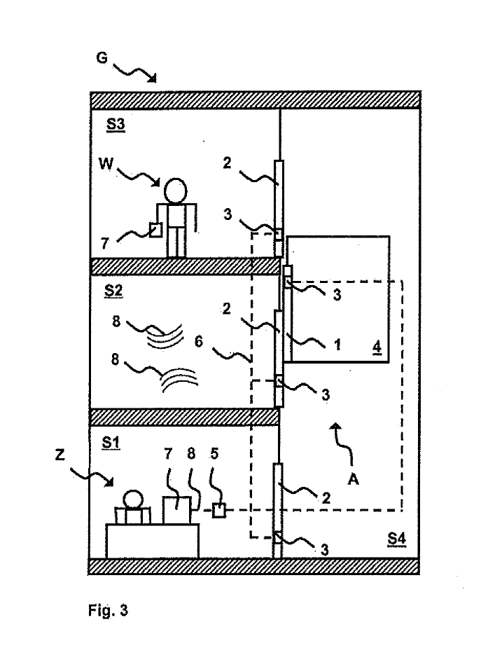

FIG. 3 shows a schematic view of a part of a third exemplifying embodiment of a lift installation with an acceleration sensor at a cage door and an acceleration sensor at each storey door;

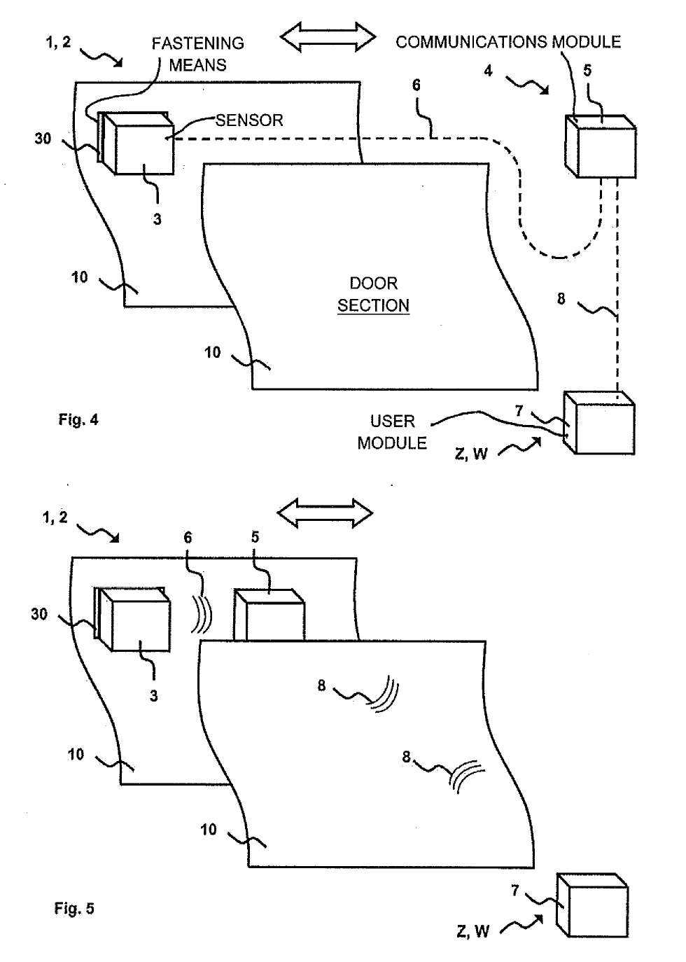

FIG. 4 shows a schematic view of a part of a fourth exemplifying embodiment of a lift installation with an acceleration sensor at a door; and

FIG. 5 shows a schematic view of a part of a fifth exemplifying embodiment of a lift installation with an acceleration sensor at a door.

FIGS. 1 to 5 show exemplifying embodiments of the invention. A lift installation A is installed in a building (G) with several storeys S1-S3. At least one cage 4 moves passengers between storeys S1-S3 of the building G in upward and downward direction. FIGS. 1 to 3 show three storeys S1-S3 and a cage 4 in a shaft S4. The cage 4 is moved by at least one cage drive (not illustrated). With knowledge of the invention the expert can, however, also realise a lift installation with several cages for a building with a greater or lesser number of storeys. The passengers can enter and leave the cage interior of the cage 4 by way of at least one door 1, 2. According to FIGS. 1 and 2 each storey S1-S3 has a storey door 2 and the cage 4 has a cage door 1. The storey doors 2 and the cage door 1 are opened and/or closed by at least one door drive (not illustrated). The invention can be realised with couplable doors 1, 2 and/or non-couplable doors 1, 2. For example, at a storey stop when the cage 4 stops at a storey S1-S3 a storey door 2 is coupled with the cage door 1 and opened and closed together by a door drive. The door drive can be arranged at the cage door 1 and/or at the storey door 2. However, it is also possible to not couple the doors 1, 2 with one another, so that each door 1, 2 has an own door drive. With knowledge of the invention the expert can obviously also realise a lift installation A with a cage with several cage doors, for example with a first cage door at a front side of the cage and with a second cage door at a rear side of the cage. Correspondingly, two storey doors are also then provided for each storey so that each of the cage doors can be coupled with a storey door at the storey stop.

At least one acceleration sensor 3 is mounted on a door 1, 2 of the lift installation A. The acceleration sensor 3 is, for example, a micromechanical single or multiple sensor, which is arranged on a substrate. The acceleration sensor 3 is, for example, a Hall sensor or a piezoelectric sensor or a capacitive sensor. The acceleration sensor 3 measures accelerations and/or vibrations in one, two or three axes at, for example, a resolution of 10 mg, preferably 5 mg. Vibrations are measured peak-to-peak. The acceleration sensor 3 measures four, preferably 32, preferably 128, accelerations and/or vibrations per second. The acceleration sensor 3 has at least one output, at which measured accelerations or vibrations can be tapped as acceleration signals. The acceleration sensor 3 has dimensions of 50×50×10 mm³, preferably 30×30×5 mm³, preferably 20×20×2 mm³, and weighs 10 grams, preferably 5 grams. With knowledge of the present invention the expert can use other measurement principles of acceleration sensors.

The acceleration sensor 3 is mounted on a cage door 1 and/or a storey door 2 of the lift installation A. In the case of couplable doors 1, 2, one acceleration sensor 3 is sufficient in order to detect accelerations and/or vibrations of coupled doors 1, 2. In the case of non-couplable doors 1, 2, one acceleration sensor 3 is necessary per door 1, 2 in order to detect accelerations and/or vibrations of the doors 1, 2. In order to obtain a redundancy in the measuring of the acceleration signals of a door 1, 2, the expert can use more than one acceleration sensor 3 per door 1, 2. According to FIG. 1, one acceleration sensor 3 is mounted on the cage door 1 and according to FIG. 2 one acceleration sensor 3 is mounted on each storey door 2. According to FIG. 3 a first acceleration sensor 3 is mounted on the cage door 1 and further acceleration sensors 3 are mounted on each storey door 2. In all of the exemplifying embodiments the doors 1, 2 can be coupled and/or non-coupled.

The acceleration sensor 3 is mounted on at least one movable door section 10 of the door 1, 2. The movable door section 10 is a door panel, a door strip, etc. According to FIGS. 4 and 5 the plane of the door movement during opening and/or closing of the door 1, 2 is illustrated by a double arrow. The acceleration sensor 3 is mounted on the door section by a reversible and/or an irreversible fastening means 30. The fastening means 30 is, for example, a force-coupling means such as a magnet and/or a material-coupling means such as an adhesive layer and/or a shape-coupling means such as a rivet. The fastening means 30 is, for example, a force-coupling and shape-coupling means such as a screw. The acceleration sensor 3 is mounted between two door sections 10 in the interior of the door 1, 2 to be imperceptible to a passenger of the lift installation A.

The acceleration sensor 3 communicates acceleration signals to at least one communications module 5. For that purpose the acceleration sensor 3 is connected by way of at least one communications path 6 with the communications module 5. The communications path 6 can be realised as a signal cable or radio connection. In FIGS. 1 to 5 a radio connection is illustrated by curved multiple lines and a signal cable is illustrated by a dashed line. Known radio connections transmit signals or signal sequences as radio waves. Known signal cables comprise at least one copper wire and/or at least one glass fibre.

Usually, the radio connection 6 between the acceleration sensor 3 and the communications module 5 is established with a sender and a receiver. In that case, the acceleration sensor 3 is at least a sender, and the communications module 5 is at least a receiver. In this way, a unidirectional transmission of information between the acceleration sensor 3 and the communications module 5 is realized. The sender is advantageously a passive sender, similar to an RFID, needing no electric source of its own. Such a sender is, for example, contactlessly provided with inductive energy.

In an alternative embodiment, the communications module 5 is also a sender and the acceleration sensor 3 is also a receiver. Thus a bidirectional transmission of information between the acceleration sensor 3 and the communications module 5 is realized, and the acceleration sensor 3 can be queried through the communications module 5.

The communications module 5 therefore has at least one input for reception of communicated acceleration signals. The communications module 5 comprises at least one processor and at least one computer readable data memory, which are arranged in and/or at the housing of the communications module 5. The processor and the computer readable data memory are arranged on a circuitboard and connected together by way of at least one signal line. At least one computer program means is loaded from the computer readable data memory into the processor and executed. The computer program means establishes a communication between the communications module 5 and the acceleration sensor 3 and maintains this communication.

The communications module 5 is mounted in stationary position at the lift installation A and/or the communications module 5 is mounted at the cage 4 or at the movable door section 10 of the door 1, 2 to be mobile. According to FIGS. 2 and 3 the communications module 5 is mounted in stationary position in the shaft S4 (FIG. 2), in the storey S1 and/or the control station Z (FIG. 3). According to FIGS. 1, 4 and 6 the communications module 5 is mounted at the cage 4 (FIGS. 1 and 4) and/or at the movable door section 10 of the door 1, 2 (FIG. 5) to be mobile.

When the communications module 5 is positioned on the cage 4, the communications module 5 is advantageously near the acceleration sensor 3. Accordingly, the communications module 5 is on the cage structure in the area of the movable door leaf on which the acceleration sensor 3 is attached. In this way, short radio transmission distances are achieved.

The communication between the acceleration sensor 3 and the communications module 5 can be unidirectional or bidirectional. In the case of a unidirectional communication the acceleration sensor 3, automatically or in response to an electromagnetic field, communicates acceleration signals and in the case of a bidirectional communication the communications module 5 can additionally communicate, by way of at least one output, interrogations to at least one input of the acceleration sensor 3. When multiple sensors are present, each acceleration sensor 3 is identifiable by a unique address. The communication between the acceleration sensor 3 and the communications module 5 can be carried out in accordance with a known bus protocol such as Universal Serial Bus (USB), Local Operating Network (LON), Modbus, etc.; it can, however, also be carried out according to a known near field communications standard such as Bluetooth (IEEE 802.15.1), ZigBee (IEEE 802.15.4) and WiFi (IEEE 802.11).

According to FIGS. 1, 3 and 4 a signal cable is realised as communications path 6 between the acceleration sensor and the communications module 5. The signal cable can be a USB cable which, apart from the communication of the acceleration signals, also provides an electrical power supply of the acceleration sensor 3. According to FIG. 4 the USB cable is realised with a length compensation between the movable door section 10 of the door 1, 2 and the stationary communications module 5 in such a manner that compensation is provided by the length compensation for the door movement during opening and/or closing of the door 1, 2.

According to FIGS. 2 and 5 a radio connection is realised as communications path 6 between the acceleration sensor 3 and the communications module 5. The radio connection can be effected in accordance with Bluetooth, ZigBee or WiFi, or it can be passive. The electrical power supply of the acceleration sensor 3 can be carried out in cable-bound manner, for example by a direct voltage 5 V or 9 V. The electrical power supply of the acceleration sensor 3 and/or of the communications module 5 can, however, also be effected by an energy store such as a battery, an accumulator, a fuel cell, etc. The energy supply is mounted at the movable door section 10, for example between two door panels 10. The energy store is, for example, designed for independence of the acceleration sensor 3 and/or of the communications module 5 in terms of energy of a year, preferably two or more years. The electrical power supply is renewed by exchange of the energy store. This exchange can be carried out by a maintenance engineer W.

The communications module 5 can bidirectionally communicate in at least one network 8 with at least one user module 8. For that purpose the computer program means of the communications module 5 establishes a communication between the communications module 5 and the central station Z and/or the maintenance engineer W and maintains this communication.

The network 8 can be realised by radio network and/or fixed network. In FIGS. 1 to 5 a radio network is illustrated by curved multiple lines and a fixed network is illustrated by a dashed line. Known radio networks are Global System for Mobile Communication (GSM), Universal Mobile Telecommunications Systems (UMTS), Bluetooth, Zigbee or WiFi. Known fixed networks are the cable-bound Ethernet, Power Line Communication (PLC), etc. PLC allows data transmission by way of the electrical power supply of the cage 4 or by way of other existing lines of the cage 4. Known network protocols for communication are TCP/IP, UDP or IPX.

In alternative embodiments, the radio connection 6 uses the communications module 5 as well as the user module 7 for a sender and a receiver for bidirectional communication over the radio network 8. In case the communications module 5 is already equipped for a radio-based, bidirectional communication with the acceleration sensor 3, the present sender and/or receiver can be used.

According to FIGS. 2, 3 and 4 a fixed network is realised between the communications module 5 and the user module 7 as network 8. The communications module 5 is then, for example, a fixed network modem. According to FIGS. 1, 3 and 5 a radio network is realised between the communications module 5 and the user module 7 as network 8. The communications module 5 is then, for example, a radio network modem. According to FIG. 3 the communications module 5 is not only a fixed network modem for communication with a central station Z, but also a radio network modem for communication with a maintenance engineer W.

The acceleration signals communicated by the acceleration sensor 3 to the communications module 5 are communicated by the communications module 5 in the network 8 to at least one user module 7. The user module 7 can be located in at least one central station Z and/or with at least one maintenance engineer W. The central station Z is stationary and can be located remotely from the building G or in the building G. According to FIG. 2 the central station Z is located remotely from the building G as a remote maintenance station and according to FIG. 3 the central station Z is located in the building G as a building central station. The maintenance engineer W is mobile and can be located not only in the remote maintenance centre, i.e. in a building central station, but also in accordance with FIG. 1 en route from the remote maintenance centre to the building G or according to FIG. 3 in the building G.

The user module 7 has at least one corresponding communications module and can bidirectionally communicate in the network 8 with the communications module 5 of the lift installation A. The user module 7 comprises at least one processor and at least one computer readable data memory, which are arranged in and/or at the housing of the user module 7. The processor and the computer readable data memory are arranged on a circuitboard and connected together by way of at least one signal line. At least one computer program means is loaded from the computer readable data memory into the processor and executed. The computer program means establishes a communication between the user module 7 and the communications module 5 and maintains this communication.

The computer program means of the communications module 5 and/or of the user module 7 evaluates communicated acceleration signals. The evaluation of the acceleration signals supplies maintenance data such as an “acceleration of the door” and/or an “acceleration of the cage”. The acceleration is detected in directionally dependent manner and differentiated into maintenance data such as an “opening acceleration or closing acceleration of the door” and/or an “upward acceleration and/or downward acceleration of the cage”. A simple integration of the acceleration signals over time supplies maintenance data such as a “speed of the door” and/or a “speed of the cage”. The speed is similarly detected in directionally dependent manner and differentiated into maintenance data such as an “opening speed or closing speed of the door” and/or an “upward speed and/or downward speed of the cage”. A double integration of the acceleration signals over time supplies maintenance data such as a “travel path of the door” and/or a “travel path of the cage”. The travel path is also detected in directionally dependent manner and differentiated into maintenance data such as an “opening travel path or closing travel path of the door” and/or an “upward travel path or downward travel path of the cage”.

The computer program means further determines an item of maintenance information “time instant of the start of acceleration of the door” and an item of maintenance information “time instant of the end of deceleration of the door” in the evaluation. The computer program means determines therefrom at least one item of maintenance information such as a “number of door movements”. The computer program means determines from the difference of the time instants as item of maintenance information a “time duration of the door movement”. In addition, the computer program means determines an item of maintenance information “time instant of the start of deceleration of the cage” and an item of maintenance information “time instant of the end of acceleration of the cage”. The computer program means determines therefrom an item of maintenance information such as a “number of cage journeys” and/or a “number of storey stops of the cage”. In addition, the computer program means determines from the difference of these time instants as item of maintenance information a “time duration of a cage journey” and/or a “time duration of a storey stop of the cage”.

Items of maintenance information such as a “number of door movements” and/or a “number of cage journeys” and/or a “number of storey stops of the cage” and/or a “time duration of a cage journey” and/or a “time duration of a storey stop of the cage” can be summated in freely selectable time windows. This summation can be carried out in storey-specific manner. An item of maintenance information “time plot of the door movements” and/or “time plot of the cage journeys”, and/or “time plot of the storey stops of the cage” is provided as result of this summation. By a time plot of a state magnitude there is understood the behaviour over time of the state magnitude. The “time plot of the door movements” and/“time plot of the cage journeys” and/or the “time plot of the storey stops of the cage” accordingly indicates the door movements, cage journeys and/or storey stops, respectively, coded in terms of time.

Acceleration signals of a triple-axis acceleration sensor supply, as items of maintenance information and/or “horizontal vibrations of the door” and/or “vertical vibrations of the door” and/or “horizontal vibrations of the cage” or vertical vibrations of the cage”.

An alarm report and/or a serviceability report is generated by the processor in dependence on items of maintenance information. For that purpose the computer program means compares at least one item of maintenance information with at least one reference value. The reference value is loaded by way of the signal line from the computer readable data memory into the processor. In the case of a negative comparison result at least one alarm report is generated and in the case of a positive comparison result at least one serviceability report is generated.

The computer program means determines a degree of correspondence of the item of maintenance information “acceleration of the door” with a reference value in the form of a reference acceleration of the door. A normal door acceleration is present when the “acceleration of the door” is less than 0.3 m/sec². The computer program means determines a degree of correspondence of the item of maintenance information “acceleration of the cage” with a reference value in the form of a reference acceleration of the cage. A normal cage acceleration is present when the “acceleration of the cage” is less than 2.0 m/sec².

The computer program means determines a degree of correspondence of the item of maintenance information “speed of the door” with a reference value in the form of a reference speed of the door. A normal door speed is present when the “speed of the door” is less than 1.0 m/sec. The computer program means determines a degree of correspondence of the item of maintenance information “speed of the cage” with a reference value in the form of a reference speed of the cage. A normal cage speed is present when the “speed of the cage” is less than 10 m/sec, preferably less than 17 m/sec.

The computer program means determines a degree of correspondence of the item of maintenance information “travel path of the door” with a reference value in the form of a reference travel path of the door. A normal door movement is present, i.e. the door is completely opened and/or closed, when the “travel path of the door” is at least 99% of the reference travel path of the door. The computer program means determines a degree of correspondence of the item of maintenance information “travel path of the cage” with a reference value in the form of a reference travel path of the cage. A normal cage travel is present, i.e. the cage is located completely at the storey stop so that the thresholds of cage door and storey door are substantially flush, when the “travel path of the cage” is at least 99% of the reference travel path of the cage. The thresholds of cage door and storey door are typically flush when the height difference between the cage floor and the storey floor is less than 15 mm, preferably less than 10 mm, so that a passenger does not trip when entering and/or leaving the cage.

The computer program means determines a degree of correspondence of the item of maintenance information “time duration of the door movement” with a reference value in the form of a reference time duration of the door movement. A normal door movement is present when the “time duration of the door movement” is between 3.5 and 3.0 sec. A slow door movement is present when the “time duration of the door movement” is more than 3.5 sec. The computer program means determines a degree of correspondence of the item of maintenance information “time duration of the cage travel” with a reference value in the form of a reference time duration of the cage travel. A normal cage travel is present when the “time duration of the cage travel” is less than 2 min. The computer program means determines a degree of correspondence of the item of maintenance information “time duration of a storey stop of the cage” with a reference value in the form of a reference time duration of a storey stop of the cage. A normal storey stop is present when the “time duration of a storey stop of the cage” is less than 60 sec.

The computer program means determines a degree of correspondence of the item of maintenance information “number of door movements” with a reference value in the form of a reference number of door movements. A preventative maintenance of the door is recommended whenever the “number of door movements” attains a resettable value of 20,000. The computer program means determines a degree of correspondence of the item of maintenance information “number of cage journeys” with a reference value in the form of a reference number of the cage journeys. A preventative maintenance of the door is recommended every time the “number of cage journeys” attains a resettable value of 10,000. The computer program means determines a degree of correspondence of the item of maintenance information “number of storey stops” with a reference value in the form of a reference number of storey stops. A preventative maintenance of the door is recommended every time the “number of storey stops” attains a resettable value of 10,000.

The computer program means determines the degree of correspondence of the detected vibrations with reference values in the form of reference vibrations. The degree of correspondence can be measured in mg and quantified. For example, horizontal vibrations are still acceptable if they lie in the region of greater than or equal to 13 to 16 mg; horizontal vibrations are low when they lie in the range of greater than or equal to 10 to 13 mg and horizontal vibrations are very small when they lie below 10 mg. Correspondingly, vertical vibrations are still acceptable when they lie in the region of greater than or equal to 15 to 18 mg; vertical vibrations are low when they lie in the region of greater than or equal to 10 to 15 mg and vertical vibrations are very small when they lie below 10 mg.

The computer program means determines a degree of correspondence of the item of maintenance information “time plot of the door movements” with a reference value in the form a reference time plot of the door movements. A preventative maintenance of the door is recommended as soon as the “time plot of door movements” deviates from the reference time plot of the door movements. The computer program means determines a degree of correspondence of the item of maintenance information “time plot of the cage journeys” with a reference value in the form of a reference time plot of the cage journeys. A preventative maintenance of the door is recommended as soon as the “time plot of the cage journeys” deviates from the reference time plot of the cage journeys. The computer program means determines a degree of correspondence of the item of maintenance information “time plot of the storey stops of the cage” with a reference value in the form of a reference time plot of the storey stops of the cage. A preventative maintenance of the door is recommended as soon as the “time plot of the storey stops of the cage” deviates from the reference time plot of the storey stops of the cage.

An alarm report is generated if an “acceleration of the door” and/or an “acceleration of the cage” and/or a “speed of the door” and/or a “speed of the cage” and/or a “travel path of the door” and/or a “travel path of the cage” and/or a “time duration of the door movement” and/or a “time duration of the cage journey” and/or a “time duration of a storey stop of the cage” and/or a “number of door movements” and/or a “number of cage journeys” and/or a “number of storey stops of the cage” and/or “horizontal vibrations of the door” and/or “vertical vibrations of the door” and/or “horizontal vibrations of the cage” and/or “vertical vibrations of the cage” exceeds a reference value.

An alarm report is generated if a “time plot of the door movement” and/or a “time plot of the cage journeys” and/or a “time plot of the storey stops of the cage” deviates from a reference value.

A serviceability report is generated if an “acceleration of the door” and/or an “acceleration of the cage” and/or a “speed of the door” and/or a “speed of the cage” and/or a “travel path of the door” and/or a “travel path of the cage” and/or a “time duration of the door movement” and/or a “time duration of the cage journey” and/or a “time duration of a storey stop of the cage” and/or a “number door movements” and/or a “number of cage journeys” and/or a “number of storey stops of the cage” and/or “horizontal vibrations of the door” and/or “vertical vibrations of the door” and/or “horizontal vibrations of the cage” and/or “vertical vibrations of the cage” falls below a reference value.

The communications module 5 communicates an alarm report to the user module 7 of the central station Z and/or to the user module 7 of the maintenance engineer W. The communications module 5 communicates the alarm report together with detected acceleration signals and/or with at least one item of maintenance information. The central station Z investigates the detected acceleration signals and/or item of maintenance information, communicated with the alarm report and if a disturbance of the lift installation A, which is linked with the alarm report, cannot be eliminated in another mode and manner summons at least one maintenance engineer W who undertakes appropriate maintenance of the lift installation A in the building G.

The maintenance engineer W can investigate the item of maintenance information “time plot of the door movement”, which was transmitted by the communications module 5, either in the central station Z or also on the way to the lift installation A and thus determine the quality of the door movement specifically to storey without, as previously usual, he or she having to go on site to each storey S1-S3 to check the correct opening and closing of the doors 1, 2. This saves time and cost.

The central station Z and/or the maintenance engineer W can derive from the item of maintenance information “time plot of the cage journeys” a favourable point in time for a maintenance visit where, in particular, little traffic is anticipated and a possible switching-off of a cage 4 of the lift installation A causes little disturbance.

An existing lift installation of at least one door 1, 2 and at least one cage 4 can be modernised in simple manner in that at least one acceleration sensor 3 is mounted on the door 1, 2; at least one communications module 5 is mounted in stationary position at the lift installation A or at the cage 4 to be mobile; and the acceleration sensor 3 is connected with the communications module 5 by way of at least one communications path 6.

1. Lift installation (A) with at least one door (1, 2) and at least one acceleration sensor (3), characterised in that the acceleration sensor (3) is mounted on the door (1, 2), the door (1, 2) being a cage door (1) and/or a storey door (2), the acceleration sensor (3) being positioned on the door (1, 2) and detecting accelerations and/or vibrations of the door (1, 2), characterised in that the acceleration sensor (3) is mounted on at least one movable door section (10) of the door (1, 2) by way of at least one fastening means (30).

2. Lift installation (A) according to claim 1, characterised in that the door (1, 2) is a cage door (1) of a cage (4) and that the acceleration sensor (3) detects accelerations and/or vibrations of the cage (4).

3. Lift installation (A) according to claim 2, characterised in that the acceleration sensor (3) detects accelerations and/or vibrations of the cage door (1) at the storey stop when the cage (4) is stationary; and that the acceleration sensor (3) detects accelerations and/or vibrations of the cage (4) during travel of the cage (4) when the cage door (1) is stationary.

4. Lift installation (A) according to one of claims 1 to 3, characterised in that the acceleration sensor (3) communicates accelerations and/or vibrations of the door (1, 2) to at least one communications module (5) by way of at least one communications path (6),
and/or characterised in that the acceleration sensor (3) communicates accelerations and/or vibrations of the cage (4) to at least one communications module (5) by way of at least one communications path (6).

5. Lift installation according to claim 4, characterised in that the acceleration sensor (3) communicates accelerations and/or vibrations of the door (1, 2) as acceleration signals over a radio connection (6) to at least one communications module (5), which is positioned on the cage or in a fixed location in the lift installation (A).

6. Lift installation (A) according to one of claim 4 or 5, characterised in that the communications module (5) sends detected acceleration signals or maintenance information over a radio network to at least one user module (7).

7. Lift installation (A) according to one of claims 4 to 6, characterised in that the communications module (5) is mounted in a stationary position at the lift installation (A),
or that the communications module (5) is mounted mobile at the cage (4),
or that the communications module (5) is mounted mobile on at least one movable door section (10) of the door (1, 2),
or that the communications module (5) is mounted mobile on at least one movable door section (10) of the door (1, 2), and that at least one energy store is mounted on at least one movable door section (10) of the door (1, 2), the energy store providing electricity to the acceleration sensor (3) and/or the communications module (5),
or that the communications module (5) is mounted mobile on at least one movable door section (10) of the door (1, 2), that at least one energy store is mounted on at least one moveable door section (10) of the door (1, 2), the energy store providing the acceleration sensor (3) and/or the communications module (5) with electricity, the energy store being configured to provide energy independence for the acceleration sensor (3) and/or the communication module (5) for one year.

8. Lift installation (A) according to one of claims 4 to 7, characterised in that the communications path (6) is a signal cable like a USB cable, and that the USB cable provides a electricity to the acceleration sensor (3) along with transmitting the acceleration signals,
and/or that the communication path (6) is a radio connection like Bluetooth and/or ZigBee and/or WiFi.

9. Lift installation (A) according to any one of claims 4 to 8, characterised in that the communications module (5) bidirectionally communicates in at least one network (8) with at least one user module (7), and that the user module (7) is arranged in at least one central station (Z) or is with at least one maintenance engineer (W).

10. Lift installation (A) according to claim 9, characterised in that the central station (Z) is located remotely from the building (G) of the lift installation (A) and/or that the central station (Z) is placed in the building (G) of the lift installation (A),
and/or that the network (8) is a radio network and/or a wired network,
and/or that the communications module (5) transmits a detected acceleration signal alarm to the user module (7),
and/or that the communications module (5) transmits at least one maintenance information alarm to the user module (7),
and/or that the communications module (5) transmits at least one alarm to the user module (7).

11. Lift installation (A) according to one of claims 1 to 10, characterised in that the movable door section (10) is a door panel,
and/or that the movable door section (10) is a door strip,
and/or that the fastening means (30) is a means coupling by way of force,
and/or that the fastening means (30) is a means coupling by way of material,
and/or that the fastening means (30) is a means coupling by way of shape,
and/or that the fastening means (30) is a means coupling by way of force and shape,
and/or that the acceleration sensor (3) is mounted between two door sections (10) in the interior of the door (1, 2) to be imperceptible to a passenger of the lift installation (A),
and/or that the acceleration sensor (3) has dimensions of 50×50×10 mm³, preferably 30×30×5 mm³, preferably 20×20×2 mm³; and that the acceleration sensor (3) weighs 10 grams, preferably 5 grams.

12. Method of maintenance of a lift installation (A) with at least one door (1, 2) and at least one acceleration sensor (3), wherein accelerations and/or vibrations of the door (1, 2) are detected by the acceleration sensor (3), characterised in that accelerations and/or vibrations, which are detected by the acceleration sensor (3), of the door (1, 2) are communicated as acceleration signals to at least one communications module (5) by way of at least one communications path (6); and that acceleration signals detected by the communications module (5) are communicated to the user module (7) by way of at least one network (8).

13. Method according to claim 12, characterised in that at least one computer program means is loaded by way of at least one signal line from at least one computer readable data memory into at least one processor of the communications module (5) or of the user module (7); and that detected acceleration signals are evaluated by the computer program means.

14. Method according to claim 13, characterised in that “acceleration of the door” and/or “acceleration of the cage” and/or “opening acceleration or closing acceleration of the door” and/or “upward acceleration or downward acceleration of the cage” and/or “speed of the door” and/or “speed of the cage” and/or “opening speed or closing speed of the door” and/or “upward speed or downward speed of the cage” and/or “travel path of the door” and/or “travel path of the cage” and/or “opening travel path or closing travel path of the door” and/or “upward travel path or downward travel path of the cage” and/or “time instant of the start of acceleration of the door” and/or “time instant of the end of deceleration of the door” and/or “number of door movements” and/or “time duration of the door movement” and/or “time instant of the start of acceleration of the cage” and/or “time instant of the end of deceleration of the cage” and/or “number of cage journeys” and/or “number of storey stops of the cage” and/or “time duration of a cage journey” and/or “time duration of a storey stop of the cage” and/or “horizontal vibrations of the door” and/or “vertical vibrations of the door” and/or “horizontal vibrations of the cage” and/or “vertical vibrations of the cage” is evaluated from the detected acceleration signals as at least one item of maintenance information.

15. Method according to one of claim 12 or 14, characterised in that at least one item of maintenance information “number of door movements” and/or “number of cage journeys” and/or “number of storey stops of the cage” and/or “time duration of a cage journey” and/or “time duration of a storey stop of the cage” is summated in freely selectable time windows; and that an item of maintenance information “time plot of the door movements” and/or “time plot of the cage journeys” and/or “time plot of the storey stops of the cage” is provided as the result of the summation,
and/that at least one item of maintenance information “number of door movements” and/or “number of cage journeys” and/or “number of storey stops of the cage” and/or “time duration of a cage journey” and/or “time duration of a storey stop of the cage” is summated in freely selectable time windows; and that an item of maintenance information “time plot of the door movements” and/or “time plot of the cage journeys” and/or “time plot of the storey stops of the cage” is provided as the result of the summation; and that the summation of a maintenance item information is performed floor-specific,
and/or that at least one item of maintenance information is compared by the computer program means with at least one reference value; and that the reference value is loaded by way of the signal line from the computer readable data memory into the processor.

16. Method according to any one of claims 13 to 15, characterised in that at least one item of maintenance information is compared by the computer program means with at least one reference value; and that the reference value is loaded by way of the signal line from the computer readable data memory into the processor; that in the case of a negative comparison result at least one alarm report is generated by the computer program means; and that in the case of a positive comparison result at least one serviceability report is generated by the computer program means.

17. Method according to claim 16, characterised in that an alarm report and/or a serviceability report is generated when an “acceleration of the door” and/or an “acceleration of the cage” and/or a “speed of the door” and/or a “speed of the cage” and/or a “travel path of the door” and/or a “travel path of the cage” and/or a “time duration of the door movement” and/or a “time duration of the cage journey” and/or a “time duration of a storey stop of the cage” and/or a “number door of movements” and/or a “number of cage journeys” and/or a “number of storey stops of the cage” and/or “horizontal vibrations of the door” and/or “vertical vibrations of the door” and/or “horizontal vibrations of the cage” and/or “vertical vibrations of the cage” and/or a “time plot of the door movements” and/or a “time plot of the cage journeys” and/or a “time plot of the storey stops of the cage” exceeds or falls below a reference value,
and/or that an alarm report is generated when a “time plot of the door movement” and/or a “time plot of the cage journeys” and/or a “time plot of the storey stops of the cage” deviates from a reference value,
and/or that a serviceability report is generated when an “acceleration of the door” and/or an “acceleration of the cage” and/or a “speed of the door” and/or a “speed of the cage” and/or a “travel path of the door” and/or a “travel path of the cage” and/or a “time duration of the door movement” and/or a “time duration of the cage journey” and/or a “time duration of a storey stop of the cage” and/or a “number of door movements” and/or a “number of cage journeys” and/or a “number of storey stops of the cage” and/or “horizontal vibrations of the door” and/or “vertical vibrations of the door” and/or “horizontal vibrations of the cage” and/or “vertical vibrations of the cage” falls below a reference value.

18. Method according to one of claim 16 or 17, characterised in that acceleration signals detected by the communications module (5) and/or at least one item of maintenance information or at least one alarm report is and/or are communicated in the network (8) to at least one user module (7) by at least one central station (Z) and/or by at least one maintenance engineer (W).

19. Method according to claim 18, characterised in that if an alarm report is communicated to the central station (Z), acceleration signals communicated with the alarm report and/or an item of maintenance information communicated with the alarm report is or are investigated by the central station (Z); and that if at least one disturbance, which is linked with the alarm report, of the lift installation (A) cannot be eliminated in another mode and manner at least one maintenance engineer (W), who undertakes appropriate maintenance of the lift installation (A) in the building (G) of the lift installation (A), is summoned by the central station (Z).

20. Method according to claim 19, characterised in that an item of maintenance information “time plot of the door movement” is investigated by the maintenance engineer (W) in the central station (Z) and/or on the way to the lift installation (A); and that the correct opening and/or closing of at least one door (1, 2) is established in storey-specific manner,
and/or that a favourable point in time, where in particular, little traffic is to be expected and a possible switching-off of a cage (4) of the lift installation (A) causes little disturbance, for a maintenance visit is derived by the central station (Z) and/or by the maintenance engineer (W) from the item of maintenance information “time plot of the cage journeys”.

21. Computer program product comprising at least one computer program means suitable for realising the method for maintenance of a lift installation (A) according to any one of claims 10 to 18 in that at least one method step is performed when the computer program means is loaded into the processor of a communications module (5) and/or of a user module (7).

22. Computer readable data memory comprising a computer program product according to claim 21.

23. Central station (Z) for use in the method for maintenance of a lift installation (A) according to any one of claims 12 to 20, characterised in that the central station (Z) is located remotely from the building (G) of the lift installation (A) and/or that the central station (Z) is located in the building (0) of the lift installation (A).

24. Method of modernising an existing lift installation with at least one door (1, 2) and at least one cage (4), characterised in that at least one acceleration sensor (3) is mounted on the door (1, 2); that at least one communications module (5) is mounted in stationary position at the lift installation (A) or to be mobile at the cage (4); and that the acceleration sensor (3) is connected with the communications module (5) by way of at least one communications path (6).

25. Method according to claim 24, characterised in that the acceleration sensor (3) is mounted on at least one movable door section (10) of the door (1, 2) by way of at least one fastening means (30),
and/or that the acceleration sensor (3) is mounted by way of at least one fastening means (30) on at least on movable door section (10) of the door (1, 2), which is used as a movable door section (10) of a door panel, and/or that the acceleration sensor (3) is mounted by way of at least one fastening means (30) on at least on movable door section (10) of the door (1, 2), which is used as a movable door section (10) of a door strip,
and/or that the acceleration sensor (3) is mounted by way of at least one fastening means (30) on at least on movable door section (10) of the door (1, 2), and that a means of coupling by way of force is used as the fastening means (30),
and/or that the acceleration sensor (3) is mounted by way of at least one fastening means (30) on at least on movable door section (10) of the door (1, 2), and that a means of coupling by way of material is used as the fastening means (30),
and/or that the acceleration sensor (3) is mounted by way of at least one fastening means (30) on at least on movable door section (10) of the door (1, 2), and that a means of coupling by way of shape is used as the fastening means (30),
and/or that the acceleration sensor (3) is mounted by way of at least one fastening means (30) on at least on movable door section (10) of the door (1, 2), and that a means of coupling by way of force and shape is used as the fastening means (30),
and/or that the acceleration sensor (3) is mounted by way of at least one fastening means (30) on at least on movable door section (10) of the door (1, 2), and that the acceleration sensor (3) is mounted between two door sections (10) in the interior of the door (1, 2) to be imperceptible to a passenger of the lift installation (A).

26. Method according to one of claim 24 or 25, characterised in that the communications module (5) is mounted in stationary position at the lift installation (A), or that the communications module (5) is mobile at the cage (4), or that the communications module (5) is mounted on at least one movable door section (10) of the door (1, 2), or that the communications module (5) is mounted on at least one moveable door section (10) of the door (1, 2), and that at least one energy store is mounted on at least one movable door section (10) of the door (1, 2), which energy stores supplies the acceleration sensor (3) or the communications module (5) with electrical power.
